(19) United States
(12) Patent Application Publication
(10) Pub. No.: US 2026/0176920 A1
(43) Pub. Date: Jun. 25, 2026

(54) FOLDING STEP LADDER

(71) Applicant: SUZHOU PICA ALUMINUM INDUSTRY LTD., Suzhou, Jiangsu (CN)

(72) Inventors: Xiaoyan XIE, Suzhou (CN); Hongwei YOU, Suzhou (CN)

(73) Assignee: SUZHOU PICA ALUMINUM INDUSTRY LTD., Suzhou, Jiangsu (CN)

(21) Appl. No.: 18/843,162

(22) PCT Filed: Jun. 6, 2023
(86) PCT No.: PCT/CN2023/098483

§ 371 Date: Aug. 30, 2024

(51) Int. Cl. E06C 1/393; E06C 1/387; E06C 7/08

(52) U.S. Cl. CPC E06C 1/393; E06C 1/387; E06C 7/082

(57) ABSTRACT

A folding step ladder includes a front ladder post; a rear ladder post, a top end of the rear ladder post is hinged to that of the front ladder post, an angle between the front and rear ladder posts is variable, so that the folding step ladder is switched between a folded state and an unfolded state; a step assembly including a first step disposed in parallel, and a front end of the first step is hinged to the front ladder post; and an opening and closing mechanism including a moving part disposed on the first step; and a guide assembly disposed on the rear ladder post and provided with a guide track matching the moving part, the guide track has a first position located at a bottom end of the guide track and a second position, in a case that the moving part is in the first position, the folding step ladder is in an unfolded state, in a case that the moving part is in the second position, the folding step ladder is in a folded state, and the guide track is provided with a stop structure to prevent the moving part from moving towards the second position in the case that the moving part is in the first position.

### CROSS-REFERENCE TO RELATED APPLICATIONS

This application is the National Phase of PCT International Application No. PCT/CN2023/098483, filed on Jun. 6, 2023, all of which is hereby expressly incorporated by reference into the present application.

### TECHNICAL FIELD

The present disclosure relates to the field of height-climbing tool, and in particular, to a folding step ladder.

### BACKGROUND

The description herein merely provides background information related to the present disclosure and does not necessarily constitute the prior art.

A step ladder is a commonly used height-climbing tool, which is widely applied both indoors and outdoors. The folding step ladder is convenient for storage and transportation due to its foldable characteristic. Traditionally, the step ladder may include a front ladder post and a rear ladder post, and a top of the front ladder post and a top of the rear ladder post may be hinged. Steps are disposed on the front ladder post. In the existing design, a connecting rod mechanism is disposed between at least one step and the rear ladder post or between the front ladder post and the rear ladder post to improve the stability of the folding step ladder in an unfolded state, thus resulting in a complicated structure.

### SUMMARY

According to various embodiments of the present disclosure, a folding step ladder with high stability and simple structure is provided.

The folding step ladder may include a front ladder post; a rear ladder post, wherein a top end of the rear ladder post may be hinged to a top end of the front ladder post, an angle between the front ladder post and the rear ladder post may be variable, so that the folding step ladder may be switched between a folded state and an unfolded state; a step assembly, wherein the step assembly may include a first step disposed in parallel, and a front end of the first step may be hinged to the front ladder post; and an opening and closing mechanism including a moving part disposed on the first step; and a guide assembly disposed on the rear ladder post and provided with a guide track matching the moving part. The guide track may have a first position and a second position, and the first position may be located at a bottom end of the guide track. In a case that the moving part is in the first position, the folding step ladder may be in an unfolded state, and in a case that the moving part is in the second position, the folding step ladder may be in a folded state. The guide track may be provided with a stop structure to prevent the moving part from moving to the second position in the case that the moving part is in the first position.

In the case that the folding step ladder mentioned above is in the unfolded state, that is, in the case that the moving part is in the first position, on one hand, the bottom end of the guide track may define the maximum value of the angle between the front ladder post and the rear ladder post. On the other hand, the stop structure may block the moving part from moving to the second position. Therefore, the moving part may be kept in the first position, that is, the folding step ladder may be kept in the unfolded state stably. In addition, the above-mentioned structure makes the structure of the folding step ladder simpler while keeps the folding step ladder stable in the unfolded state.

In one embodiment, the guide track may be a guide groove, and the moving part may be a plug-in component matching the guide groove.

In one embodiment, the moving part may be a rolling component or a sliding component.

In one embodiment, the stop structure may include a stop section of the guide track, which is close to the first position and bent laterally.

In one embodiment, the guide assembly may include a guide component fixedly disposed on the rear ladder post. The guide track may include a first guide groove disposed on the guide component, and the first guide groove may penetrate the guide component along a depth direction of the first guide groove. The guide track may include a second guide groove disposed on the rear ladder post, and the second guide groove and the first guide groove may be disposed along the depth direction of the first guide groove. The moving part may be inserted into the first guide groove and the second guide groove at the same time.

In one embodiment, the moving part may be provided with a first anti-slip portion, and the guide assembly may be provided with a second anti-slip portion matching the first anti-slip portion.

In one embodiment, the guide component may be provided with a buckle, and the rear ladder post may be provided with a slot matching the buckle.

In one embodiment, the first step may have a first stepping surface. The first stepping surface may be provided with first reinforcing ribs, and heights of the first reinforcing ribs may be not all the same, and/or the step assembly may include a second step and a linkage mechanism. A front end of the second step may be hinged to the front ladder post, and the second step may be located at a bottom side of the first step. The linkage mechanism may be configured to realize simultaneous movement of the first step and the second step. The second step may have a second stepping surface. The second stepping surface may be provided with second reinforcing ribs, and heights of the second reinforcing ribs may be not all the same.

In one embodiment, the folding step ladder may further include a rung arranged on the front ladder post.

In one embodiment, the rung may have a third stepping surface provided with third reinforcing ribs, and heights of the third reinforcing ribs may be not all the same.

The details of one or more embodiments of the present disclosure are set forth in the following drawings and description. Other features, objects, and advantages of the present disclosure will become apparent from the description, drawings, and claims.

### BRIEF DESCRIPTION OF DRAWINGS

In order to better describe and illustrate the embodiments or examples of the present disclosure disclosed herein, one or more drawings may be referred to. Additional details or examples used to describe the drawings should not be considered as limiting the scope of any one of the disclosed disclosure, the embodiments or examples currently described, and the best modes of these disclosures currently understood.

FIG. 1 is a schematic structural diagram of a folding step ladder according to one embodiment of the present disclosure.

FIG. 2 is a schematic structural diagram of the folding step ladder illustrated in FIG. 1 in a folded state.

FIG. 3a is a schematic diagram of a connection structure between a first step and a rear ladder post illustrated in FIG. 1.

FIG. 3b is a partial enlarged view of M illustrated in FIG. 3a.

FIG. 4 is a schematic structural diagram of a guide component illustrated in FIG. 3.

FIG. 5 is an exploded view of a connection between the guide component and the rear ladder post illustrated in FIG. 4.

FIG. 6 is an exploded view of a connection of an opening and closing mechanism in the folding step ladder illustrated in FIG. 1.

FIG. 7 is a schematic structural diagram of a moving part illustrated in FIG. 6.

FIG. 8 is a partial structure diagram of a first step illustrated in FIG. 1.

FIG. 9 is a side view of the first step illustrated in FIG. 8.

FIG. 10 is a partial enlarged view of A illustrated in FIG. 9.

FIG. 11 is a partial structure diagram of the rung illustrated in FIG. 1.

FIG. 12 is a side view of the rung illustrated in FIG. 11.

### DESCRIPTION OF REFERENCE NUMERALS

100, folding step ladder;
110, front ladder post;
120, rear ladder post; 121, slot;
130, step assembly; 131, first step; 131a, first stepping surface; 131b, first reinforcing rib; 131b1, first-first reinforcing rib; 131b2, first-second reinforcing rib; 131c, first end cover; 131d, second end cover; 132, second step; 133, connecting rod;
141, moving part; 141a, first anti-slid portion; 142, guide track; 143, stop section; 144, guide component; 144a, second anti-slid portion; 144b, buckle; 145, first guide groove;
150, rung; 151, third stepping surface; 152, third reinforcing rib; 152a, third-first reinforcing rib; 152b, third-second reinforcing rib;
01, screw.

### DETAILED DESCRIPTION

In order to make the purpose, technical solution, and advantages of the present disclosure clearer, the present disclosure is further described in detail below in combination with the accompanying drawings and the embodiments. It should be understood that the specific embodiments described here are only used to explain the present disclosure and are not intended to limit the present disclosure.

It should be noted that when an element is described as being “disposed on” another element, it may be directly on another element or an intervening element may exist. When an element is regarded as being “connected” to another element, it may be directly connected to another element or an intervening element may exist. The terms “vertical”, “horizontal”, “left”, “right”, and similar expressions used herein are for only illustrative purposes and do not represent only one implementation.

As used herein, the orientation or positional relationship indicated by the terms “center”, “longitudinal”, “lateral”, “length”, “width”, “thickness”, “height”, “upper”, “lower”, “front”, “back”, “left”, “right”, “vertical”, “horizontal”, “top”, “bottom”, “internal”, “external”, “clockwise”, or “counterclockwise”, etc. is an orientation or positional relationship shown in the drawings, which is only to facilitate simplifying the description of the present disclosure, and does not indicate that the device or element referred to must have a specific orientation, and be constructed and operated in the specific orientation, that is, it cannot be understood as a limitation on the present disclosure.

The terms “first” and “second” used herein are only for the purpose of clear description and cannot be understood as the relative importance of the indicated features or the number of the indicated technical features. Therefore, features defined by “first” or “second” may expressly include at least one of the features. In the description of the present disclosure, “a plurality of” means at least two, such as two, three, etc., “several” means at least one, such as one, two, three, etc., and unless explicitly limited otherwise.

The terms “mount”, “connect with”, “connect to”, “fix”, and “dispose”, etc. used in the present disclosure should be understood in a general manner. For example, “connection” may be a fixed connection, a detachable connection, or an integrated connection, it may also be a mechanical connection or an electrical connection, it may also be a direct connection, an indirect connection via an intermediate medium, internal communication of two elements, or interactive relationship of two elements. For those of ordinary skill in the art, the specific meanings of the above terms in the present disclosure may be understood according to specific conditions.

Unless expressly limited otherwise, a first feature is “on”, “upon”, “above”, “over”, “below”, “under”, “beneath”, or “underneath” a second feature may mean that the first feature directly contacts the second feature or the first feature indirectly contacts the second feature via an intermediate medium. Furthermore, the first feature is “on”, “above”, or “over” the second feature, which may mean that the first feature is directly above or diagonally above the second feature, or merely means that a horizontal height of the first feature is higher than that of the second feature. The first feature is “below”, “under”, or “underneath” the second feature, which may mean that the first feature is directly under or diagonally under the second feature, or merely means that the horizontal height of the first feature is less than that of the second feature.

Unless expressly defined otherwise, all technical and scientific terms used herein have the same meaning as commonly understood by those skilled in the art to which the present disclosure belongs. The terms used in the description of the present disclosure are for the purpose of describing specific embodiments only and are not intended to limit the present disclosure. Various technical features of the embodiments may be combined in any way. To simplify the description, not all possible combinations of various technical features in the embodiments are described. However, as long as there is no conflict in the combination of these technical features, all possible combinations should be considered to be within the scope of the present description.

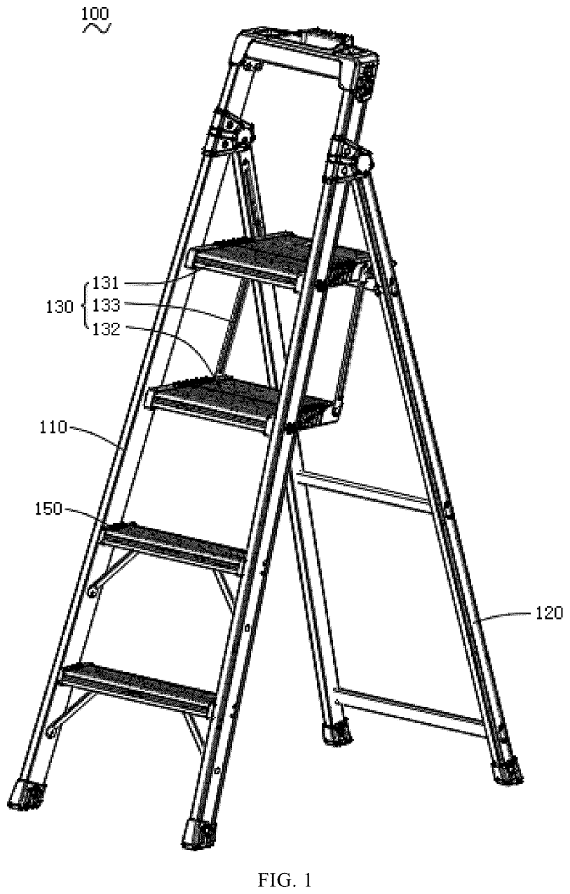

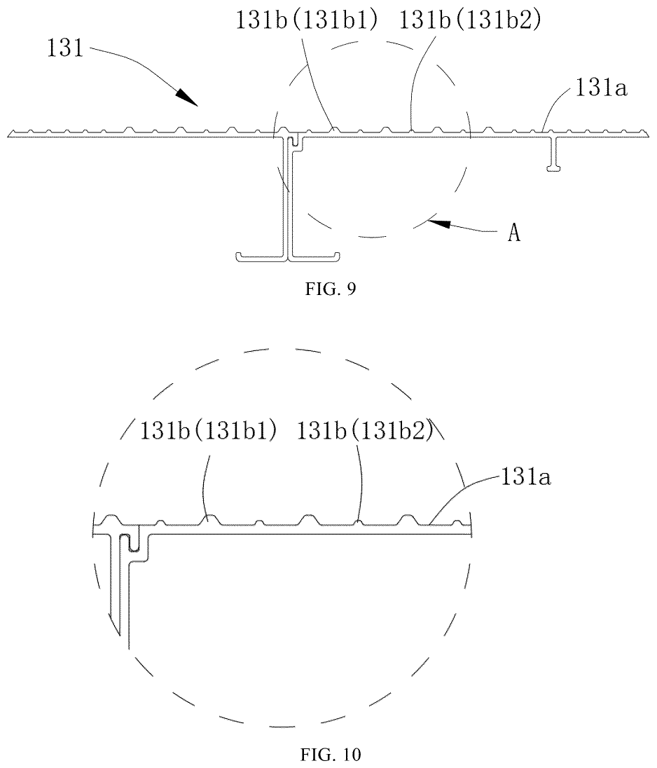

Referring to FIGS. 1 to 12, an embodiment of the present disclosure provides a folding step ladder 100 including a front ladder post 110, a rear ladder post 120, a step assembly 130, and an opening and closing mechanism.

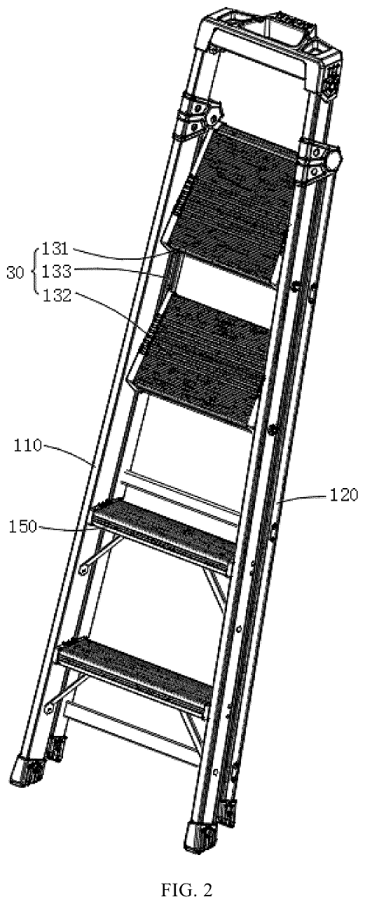

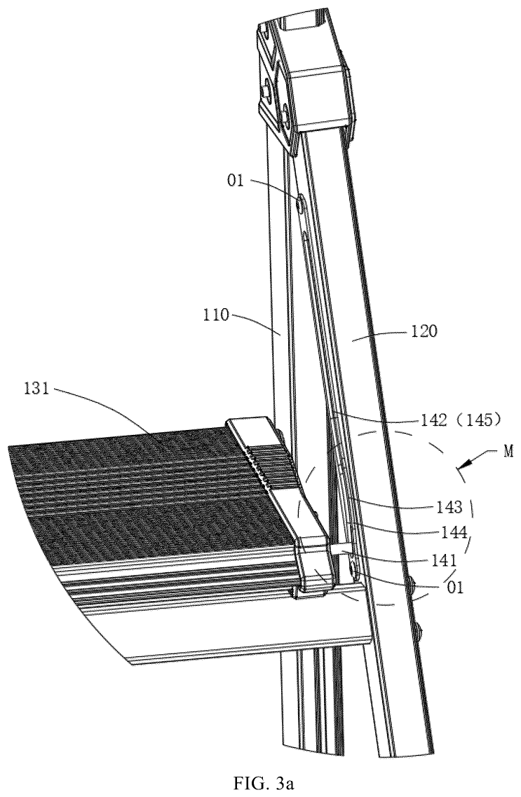

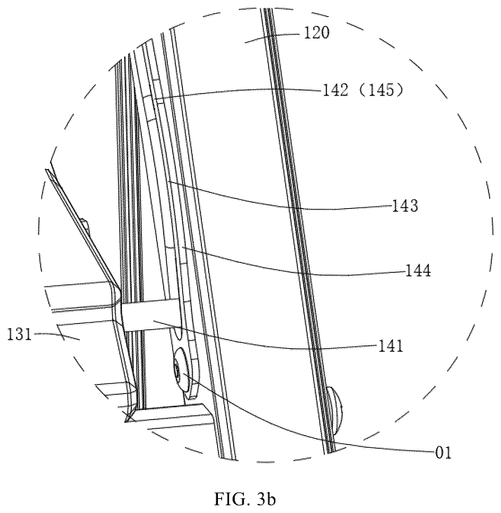

Referring to FIGS. 1 and 3b, a top end of the rear ladder post 120 is hinged to a top end of the front ladder post 110. An angle between the front ladder post 110 and the rear ladder post 120 is variable, so that the folding step ladder 100 may be switched between a folded state and an unfolded state. Specifically, in FIG. 1, the folding step ladder 100 is in the unfolded state. In FIG. 2, the folding step ladder 100 is in the folded state.

Referring to FIGS. 1 and 2, the step assembly 130 may include a first step 131 arranged in parallel. A front end of the first step 131 is hinged to the front ladder post 110.

Referring to FIGS. 1 to 3b, the opening and closing mechanism may include a moving part 141 and a guide assembly. The moving part 141 is disposed on the first step 131. The guide assembly is disposed on the rear ladder post 120. The guide assembly is provided with a guide track 142 matching the moving part 141. The guide track 142 has a first position and a second position. The first position is located at a bottom end of the guide track 142. In a case that the moving part 141 is in the first position, the folding step ladder 100 is in the unfolded state, referring to FIGS. 1, 3a and 3b. In a case that the moving part 141 is in the second position, the folding step ladder 100 is in the folded state, referring to FIG. 2. The guide track 142 is provided with a stop structure to prevent the moving part 141 from moving towards the second position in the case that the moving part 141 is in the first position.

In the case that the folding step ladder 100 mentioned above is in the unfolded state, that is, in the case that the moving part 141 is in the first position, on one hand, the bottom end of the guide track 142 may define the maximum value of the angle between the front ladder post 110 and the rear ladder post 120, on the other hand, the stop structure may block the moving part 141 from moving towards the second position. Therefore, the moving part 141 may be kept in the first position, that is, the folding step ladder 100 may be kept in the unfolded state stably. In addition, the above-mentioned structure makes the structure of the folding step ladder 100 simpler while keeping the folding step ladder 100 stable in the unfolded state.

In addition, the folding step ladder 100 has a simple structure, which can not only reduce its weight and facilitate the carrying of the ladder, but also reduce assembling difficulty and production costs.

Referring specifically to the embodiment illustrated in FIGS. 1 to 3b, the second position of the guide track 142 may be a top position of the guide track 142. When the moving part 141 is in the second position, the front ladder post 110 and the rear ladder post 120 may be approximately parallel, so that the folding step ladder 100 occupies a smaller volume in the folded state.

It is understood that, in other embodiments, the second position of the guide track may be not limited to the top position of the guide track as long as the front ladder post and the rear ladder post can be approximately parallel when the folding step ladder is in the folded state.

Referring to FIGS. 1 and 2, in the present disclosure, the step assembly 130 may further include a second step 132 approximately parallel to the first step 131, and a linkage mechanism. A front end of the second step 132 may be hinged to the front ladder post 110. The second step 132 may be located at a bottom side of the first step 131. The linkage mechanism may be used to realize simultaneous movement of the first step 131 and the second step 132.

The linkage mechanism may include two connecting rods 133. Both ends of the connecting rod 133 may be respectively hinged to the first step 131 and the second step 132, thereby realizing the linkage of the first step 131 and the second step 132, so that the first step 131 and the second step 132 may be always in an approximately parallel state.

It can be understood that, in other embodiments, the linkage mechanism may be not limited to being formed by the connecting rod shown in FIG. 1 and FIG. 2, but can also be formed by any mechanism that can realize the linkage of the first step and the second step.

Similarly, it can be understood that, in other embodiments, the step assembly is not limited to including two steps, and accordingly the arrangement of the linkage mechanism is not limited thereto.

Referring to FIG. 3a and FIG. 3b, the guide track 142 may be a guide groove. The moving part 141 may be a plug-in component matching the guide groove. Of course, it can be understood that, in other embodiments, the guide track may be not limited to the guide groove, and the moving part may be not limited to the plug-in component. The movement of the moving part may be guided, so that it moves along a predetermined trajectory.

Further, the moving part 141 shown in FIGS. 3a and 3b may be a sliding component. It can be understood that, in other embodiments, the moving part may also be a rolling component.

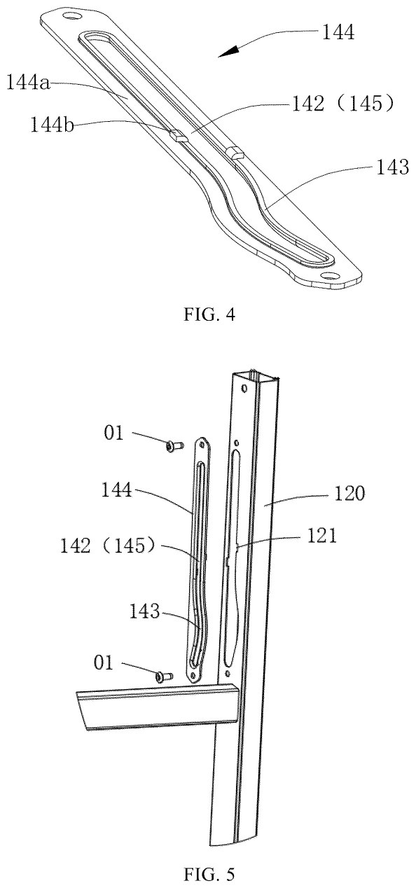

Referring to FIGS. 3a, 3b, and 4, the stop structure may include a stop section 143 of the guide track 142, which is close to the first position and bent laterally. A side wall of the stop section 143 may block the moving part 141 from moving towards the second position. Certainly, it can be understood that under the action of external force, the moving part 141 may overcome the resistance of the side wall of the stop section 143 and move to the second position.

It can be understood that, in other embodiments, the structure of the stop structure is not limited thereto as long as it can block the moving part 141 from moving to the second position.

The guide assembly may include a guide component 144 fixedly disposed on the rear ladder post 120, and the guide track 142 may include a first guide groove 145 disposed on the guide component 144.

Optionally, in other embodiments, along a depth direction of the first guide groove, the first guide groove may penetrate the guide component. The guide track may include a second guide groove disposed on the rear ladder post. The second guide groove and the first guide groove may be disposed along the depth direction of the first guide groove. The moving part may be inserted into the first guide groove and the second guide groove at the same time, thereby reducing the interaction force between the guide component and the moving part, further reducing the interaction force between the guide component and the rear ladder post, and improving the service life of the guide component and the rear ladder post, thus improving the service life of the folding step ladder.

Referring to FIGS. 4, 6, and 7, the moving part 141 may be provided with a first anti-slip portion 141a, and the guide assembly may be provided with a second anti-slip portion 144a matching the first anti-slip portion 141a, so as to prevent the moving part 141 from slipping out of the guide groove, thereby better ensuring the structural stability of the folding step ladder 100.

Specifically, the first anti-slip portion 141a may be a bump disposed on the moving part 141, and the second anti-slip portion144a may be a side wall of the guide track 142 disposed on the guide component 144. The first anti-slip portion141a may abut against a surface of the guide component 144 close to the rear ladder post 120, thereby preventing it from slipping out of the guide track 142.

Referring to FIG. 4 and FIG. 5, the guide component 144 may be provided with a buckle 144b, and the rear ladder post 120 may be provided with a slot 121 matching the buckle 144b, thereby realizing positioning and fixed connection between the guide component 144 and the rear ladder post 120. Referring to the embodiment shown in FIG. 5, the guide component 144 and the rear ladder post 120 may be fixedly connected by a screw 01. By means of the double fixing, the guide frame is more stably fixed on the rear ladder post 120.

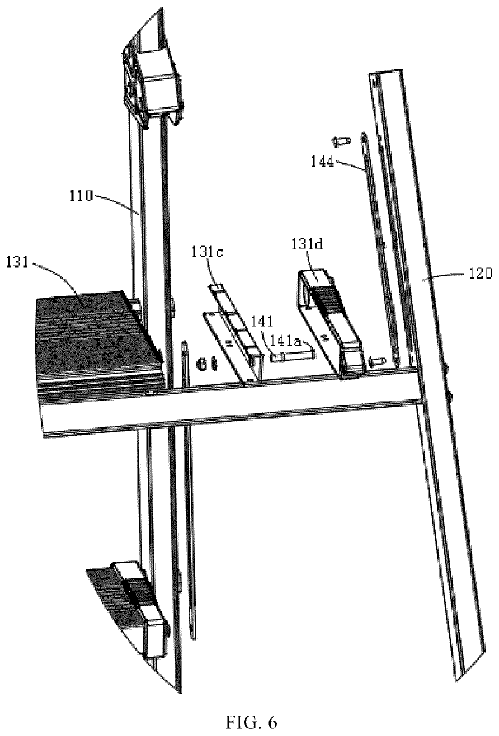

Referring to FIG. 6, a side end of the first step 131 may be provided with a first end cover 131c and a second end cover 131d. The first end cover 131c and the second end cover 131d may be both provided with through holes matching the moving part 141, and two ends of the moving part 141 may be respectively inserted into the through hole of the first end cover 131c and the through hole of the second end cover 131d, and then fixedly connected by a rivet. Certainly, it can be understood that the assembling method of the moving part 141 and the first step 131 is not limited thereto, and the assembling of the moving part 141 and the first step 131 may be achieved by any other conventional or unconventional method.

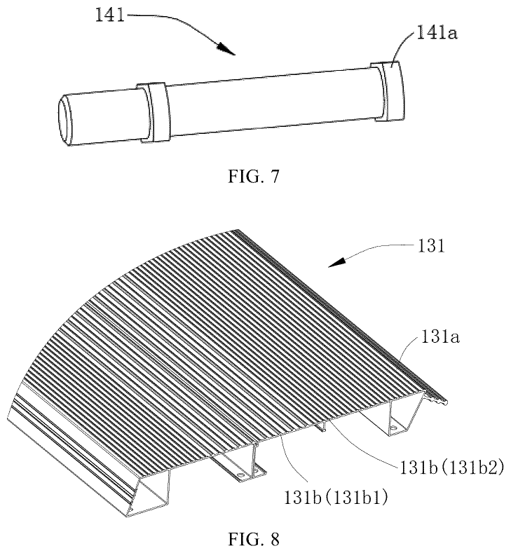

Referring to FIGS. 8 to 10, the first step 131 may have a first stepping surface 131a. The first stepping surface 131a may be provided with first reinforcing ribs 131b, and heights of the first reinforcing ribs 131b may be not completely the same. Thus, on one hand, it enhances the tactile feeling of the user when stepping on the first step 131 and improves the user experience, on the other hand, it has a better anti-slip effect, on yet the other hand, it improves the strength of the first step 131 and reduces the deformation of the ladder caused by being stepped on, thereby increasing the service life.

Specifically referring to the embodiment shown in FIGS. 8 to 10, the first stepping surface131a may have two first reinforcing ribs 131b with different heights, which may be a first-first reinforcing rib 131b1 and a first-second reinforcing rib 131b2, respectively. Certainly, it can be understood that, in other embodiments, the first stepping surface 131a may be provided with three or even more first reinforcing ribs 131b with different heights.

The second step 132 may have a second stepping surface. The second stepping surface may be provided with second reinforcing ribs, and the heights of the second reinforcing ribs may be not completely the same. The arrangement of the second reinforcing ribs on the second stepping surface can refer to the arrangement of the first reinforcing ribs 131b on the first stepping surface 131a, and will not be repeated here.

Referring to FIGS. 1 and 2, the folding step ladder may further include a rung 150 disposed on the front ladder post 110.

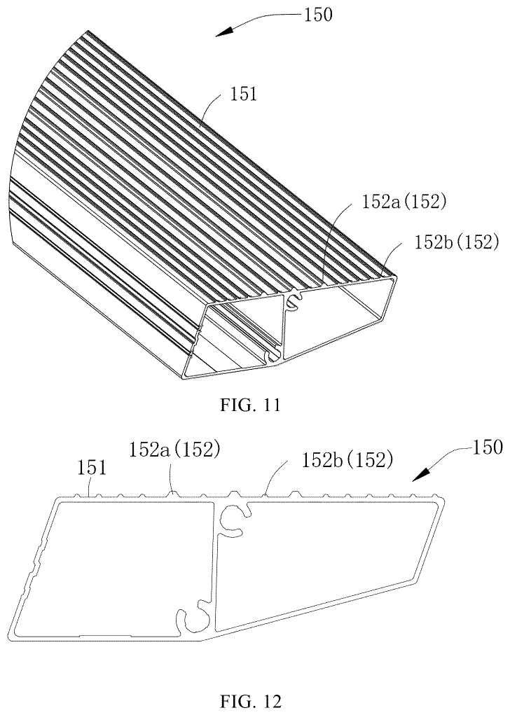

Specifically, referring to FIGS. 11 and 12, the rung 150 may have a third stepping surface 151. The third stepping surface 151 may be provided with third reinforcing ribs 152, and the heights of the third reinforcing ribs 152 may be not completely the same. Thus, on one hand, it enhances the tactile feeling of the user when stepping on the rung 150 and improves the user experience, on the other hand, it has a better anti-slip effect, on yet the other hand, it improves the strength of the rung 150, and reduces the deformation of the ladder caused by being stepped on, thereby increasing the service life.

Specifically referring to the embodiment shown in FIGS. 11 and 12, the third stepping surface 151 may be provided with two third reinforcing ribs 152 with different heights, which may be a third-first reinforcing rib 152a and a third-second reinforcing rib 152b, respectively. Certainly, it can be understood that, in other embodiments, the third stepping surface 151 may be provided with three or even more third reinforcing ribs 152 with different heights.

Various technical features in the above-described embodiments may be arbitrarily combined. To make the description concise, not all possible combinations of the various technical features in the above-described embodiments are described. However, as long as there is no conflict in the combination of these technical features, all should be considered to be within the scope of this specification.

The above-mentioned embodiments only express several implementations of the present disclosure, and the descriptions thereof are relatively specific and detailed, but it cannot be understood as limiting the scope of the present disclosure. It should be noted that, for those skilled in the art, various variations and improvements can be made without departing from the concept of the present disclosure, and these all belong to the protection scope of the present disclosure. Therefore, the protection scope of the present disclosure shall be subject to the attached claims.

1. A folding step ladder, comprising:
a front ladder post;
a rear ladder post, wherein a top end of the rear ladder post is hinged to a top end of the front ladder post, an angle between the front ladder post and the rear ladder post is variable, so that the folding step ladder is switched between a folded state and an unfolded state;
a step assembly, wherein the step assembly comprises a first step, and a front end of the first step is hinged to the front ladder post; and
an opening and closing mechanism, wherein the opening and closing mechanism comprises:
a moving part disposed on the first step; and
a guide assembly disposed on the rear ladder post,
wherein the guide assembly is provided with a guide track matching the moving part,
wherein the guide track has a first position and a second position, and the first position is located at a bottom end of the guide track,
wherein in a case that the moving part is in the first position, the folding step ladder is in an unfolded state,
wherein in a case that the moving part is in the second position, the folding step ladder is in a folded state, and
wherein the guide track is provided with a stop structure to prevent the moving part from moving towards the second position in the case that the moving part is in the first position.

2. The folding step ladder according to claim 1, wherein
the guide track is a guide groove, and
the moving part is a plug-in component matching the guide groove.

3. The folding step ladder according to claim 2, wherein the moving part is a rolling component or a sliding component.

4. The folding step ladder according to claim 2, wherein
the stop structure comprises a stop section of the guide track, and
the stop section is close to the first position and bent laterally.

5. The folding step ladder according to claim 2, wherein
the guide assembly comprises a guide component fixedly disposed on the rear ladder post,
the guide track comprises a first guide groove disposed on the guide component, and the first guide groove penetrates the guide component along a depth direction of the first guide groove,
the guide track comprises a second guide groove disposed on the rear ladder post, and the second guide groove and the first guide groove are disposed along the depth direction of the first guide groove, and
the moving part is inserted into the first guide groove and the second guide groove at the same time.

6. The folding step ladder according to claim 2, wherein
the moving part is provided with a first anti-slip portion, and the guide assembly is provided with a second anti-slip portion matching the first anti-slip portion.

7. The folding step ladder according to claim 5, wherein
the guide component is provided with a buckle, and
the rear ladder post is provided with a slot matching the buckle.

8. The folding step ladder according to claim 1, wherein
the first step has a first stepping surface, the first stepping surface is provided with first reinforcing ribs, and heights of the first reinforcing ribs are not all the same.

9. The folding step ladder according to claim 1, further comprising a rung arranged on the front ladder post.

10. The folding step ladder according to claim 9, wherein
the rung has a third stepping surface, the third stepping surface is provided with third reinforcing ribs, and heights of the third reinforcing ribs are not all the same.

11. The folding step ladder according to claim 3, wherein
the guide assembly comprises a guide component fixedly disposed on the rear ladder post,
the guide track comprises a first guide groove disposed on the guide component, and the first guide groove penetrates the guide component along a depth direction of the first guide groove,
the guide track comprises a second guide groove disposed on the rear ladder post, and the second guide groove and the first guide groove are disposed along the depth direction of the first guide groove, and
the moving part is inserted into the first guide groove and the second guide groove at the same time.

12. The folding step ladder according to claim 11, wherein
the guide component is provided with a buckle, and
the rear ladder post is provided with a slot matching the buckle.

13. The folding step ladder according to claim 4, wherein
the guide assembly comprises a guide component fixedly disposed on the rear ladder post,
the guide track comprises a first guide groove disposed on the guide component, and the first guide groove penetrates the guide component along a depth direction of the first guide groove,
the guide track comprises a second guide groove disposed on the rear ladder post, and the second guide groove and the first guide groove are disposed along the depth direction of the first guide groove, and
the moving part is inserted into the first guide groove and the second guide groove at the same time.

14. The folding step ladder according to claim 13, wherein
the guide component is provided with a buckle, and
the rear ladder post is provided with a slot matching the buckle.

15. The folding step ladder according to claim 3, wherein
the moving part is provided with a first anti-slip portion, and the guide assembly is provided with a second anti-slip portion matching the first anti-slip portion.

16. The folding step ladder according to claim 4, wherein
the moving part is provided with a first anti-slip portion, and the guide assembly is provided with a second anti-slip portion matching the first anti-slip portion.

17. The folding step ladder according to claim 1, wherein
the step assembly comprises a second step and a linkage mechanism, a front end of the second step is hinged to the front ladder post, the second step is located at a bottom side of the first step, the linkage mechanism is configured to realize simultaneous movements of the first step and the second step, the second step has a second stepping surface, the second stepping surface is provided with second reinforcing ribs, and heights of the second reinforcing ribs are not all the same.

18. The folding step ladder according to claim 1, wherein
the first step has a first stepping surface, the first stepping surface is provided with first reinforcing ribs, and heights of the first reinforcing ribs are not all the same, and
the step assembly comprises a second step and a linkage mechanism, a front end of the second step is hinged to the front ladder post, the second step is located at a bottom side of the first step, the linkage mechanism is configured to realize simultaneous movements of the first step and the second step, the second step has a second stepping surface, the second stepping surface is provided with second reinforcing ribs, and heights of the second reinforcing ribs are not all the same.

19. The folding step ladder according to claim 2, further comprising a rung arranged on the front ladder post.

20. The folding step ladder according to claim 3, further comprising a rung arranged on the front ladder post.
